(19) United States
(12) Patent Application Publication
(10) Pub. No.: US 2014/0135437 A1
(43) Pub. Date: May 15, 2014

(54) TIRE WITH RUBBER TREAD CONTAINING COMBINATION OF RESIN AND VEGETABLE OIL, PARTICULARLY SOYBEAN OIL

(71) Applicant: The Goodyear Tire & Rubber Company, Akron, OH (US)

(72) Inventors: Paul Harry Sandstrom, Cuyahoga Falls, OH (US); Stephan Rodewald, Canal Fulton, OH (US); Ahalya Ramanathan, Stow, OH (US)

(73) Assignee: The Goodyear Tire & Rubber Company, Akron, OH (US)

(21) Appl. No.: 13/677,605

(22) Filed: Nov. 15, 2012

(51) Int. Cl. C08L 9/00

(52) U.S. Cl. CPC C08L 9/00
USPC 524/313

(57) ABSTRACT

This invention relates to a tire with a circumferential rubber tread composition comprised of a silica reinforced rubber composition containing diene based polymers in combination with traction resin(s) and vegetable oil, particularly soybean oil.

### FIELD OF THE INVENTION

This invention relates to a tire with a circumferential rubber tread composition comprised of a silica reinforced rubber composition containing diene based polymers in combination with traction resin(s) and vegetable oil, particularly soybean oil.

### BACKGROUND OF THE INVENTION

Pneumatic rubber tires are often used for purposes where traction, (e.g. skid resistance of the tire tread on dry or wet road surfaces) is a significant consideration.

This requires tread rubber compositions which provide the desired good grip, or traction, but also provide good rolling resistance for fuel economy and good treadwear, or abrasion resistance, for extended tire service life.

Various traction resins have been suggested for use to improve the wet and dry traction of such tread compositions, such as for example, coumarone-indene resins, alkylated hydrocarbon resins, aromatic petroleum resins, dicyclopentadiene resins and styrene-alphamethylstyrene resins. For example, and not intended to be limiting, see U.S. Pat. Nos. 6,525,133; 6,242,523; 6,221,953 and 5,901,766.

However, such traction resins when used in tire tread rubber compositions also tend to increase treadwear, (reduce abrasion resistance) as a performance tradeoff. It has been discovered that the use of such traction resins in tread compositions which also contain silica as the reinforcing filler and soybean oil as the processing aid, provide the desired traction improvement with significantly better abrasion resistance which is predictive of better (reduced) treadwear performance and thus extended tire life. In one embodiment, it is desirable to use functionalized polymers, namely elastomers containing functional groups reactive with hydroxyl groups contained on precipitated silica, for this approach, particularly functionalized solution polymerization prepared styrene/butadiene rubber (S-SBR).

In practice, a choice of resin for a tire tread rubber composition may depend on its softening point to enhance traction of a tire rubber tread at an optimum operating temperature for the tire tread. For example, a resin with a softening point of about 30° C. might be expected to soften and become significantly hysteretic at a tire tread temperature in a range of from about 20° C. to about 50° C. and to thereby aid in providing tread traction for a tread in such temperature range. A resin with a significantly higher softening point might be desirable for a tire tread expected to operate as a significantly higher temperature (e.g. at least 100° C.).

Accordingly, it is desired to evaluate whether the addition of a combination of triglyceride based vegetable oils, (e.g. soybean oil) instead of petroleum based oils together with one or more traction resins could be used in silica reinforced rubber compositions containing diene based elastomers, particularly functionalized elastomers containing one or more functional groups reactive with hydroxyl groups contained on said precipitated silica (to promote enhanced rolling resistance and treadwear performance), particularly for road-contacting tire treads to enhance wet and dry traction while minimizing changes in rolling resistance and treadwear performance.

For such evaluation, it is important to appreciate that various vegetable oils, including soybean oil, differ significantly from petroleum based oils, particularly where such vegetable oils are triglycerides which contain a significant degree of unsaturation and clearly not a linear or an aromatic petroleum based oil.

The triglyceride(s) or vegetable oils include, for example, soybean oil, sunflower oil and canola oil which are in the form of esters containing a certain degree of unsaturation. For informational purposes to illustrate the aforesaid of relative saturated, mono unsaturated and polyunsaturated contents of various vegetable oils, the following Table A is provided.

TABLE A

| | Percent | Percent | Percent |
|---|---|---|---|
| Vegetable Oil | Saturated | Mono Unsaturated | Poly Unsaturated |
| Soybean | 16 | 23 | 58 |
| Sunflower | 10 | 45 | 40 |
| Canola (Rapeseed) | 7 | 63 | 28 |
| Corn | 13 | 28 | 55 |
| Coconut | 87 | 6 | 2 |
| Cottonseed | 26 | 18 | 52 |
| Olive | 14 | 73 | 11 |
| Palm | 49 | 37 | 9 |
| Peanut | 17 | 46 | 32 |
| Safflower | 10 | 45 | 40 |

Therefore, such vegetable oils, such as for example, soybean oil, contain a significant unsaturation content not present in petroleum based rubber processing oils.

The challenge of combining such vegetable oils (e.g. soybean oil) with diene based polymers and traction resins and silica as the reinforcement filler in an internal rubber mixer (e.g. Banbury™ mixer) is to be evaluated with results being unknown until the evaluation is undertaken.

In the description of this invention, the terms “compounded” rubber compositions and “compounds”; where used refer to rubber compositions which have been compounded, or blended, with appropriate rubber compounding ingredients. The terms “rubber”, “polymer” and “elastomer” may be used interchangeably unless otherwise indicated. The amounts of materials are usually expressed in parts of material per 100 parts of rubber by weight (phr).

### SUMMARY AND PRACTICE OF THE INVENTION

In accordance with this invention, a rubber composition is provided comprised of, based on parts by weight per 100 parts by weight of elastomer (phr):

(A) at least one conjugated diene-based elastomer, desirably including at least one conjugated diene-based elastomer that contains one or more functional groups reactive with hydroxyl groups contained on precipitated silica, and

(B) from about 5 to about 60, alternately from about 10 to about 40, phr of at least one triglyceride vegetable oil (e.g. soybean oil) and

(C) from about 1 to about 30, alternately about 2 to about 20 phr of resin comprised of at least one of coumarone-indene resins, alkylated hydrocarbon resins, aromatic petroleum resins, dicyclopentadiene resins and styrene-alphamethylstyrene resins, and

(D) from about 30 to about 140, alternately from about 50 to about 120 phr of reinforcing filler comprised of:
(1) precipitated silica, or
(2) combination of rubber reinforcing carbon black and precipitated silica (containing, for example, about 20 to about 90 weight percent of precipitated silica, alternately from about 55 to about 90 weight percent precipitated silica for a silica-rich reinforcing filler) and

(E) silica coupling agent reactive with hydroxyl groups (e.g. silanol groups) on said precipitated silica and another different moiety interactive with carbon-to-carbon double bonds of said conjugated diene-based elastomers;

wherein said rubber composition is free of oil extended elastomer (elastomer which contains petroleum based oil or vegetable oil, including soybean oil, added during the manufacturing of the elastomer).

In a first embodiment, said resin is comprised of one of said resins.

In a second embodiment, said resins are comprised of two of the same or different said resins having individual softening or melting points spaced apart by at least 20° C. from each other.

In a third embodiment, said resins are comprised of three of said resins having individual softening points spaced apart by at least 20° C. from each other.

In one aspect, said coumarone-indene resin has a softening point in a range of from about 20 to about 140° C.

In another aspect, said alkylated hydrocarbon resin has a softening point in a range of from about 40 to about 140° C.

Representative of such alkylated hydrocarbon resins are, for example and not intended to be limitive, are copolymers of butene and other alpha-olefin comonomers.

In a further aspect, said aromatic petroleum resin has a softening point in a range of from about 40 about 160° C.

In an additional aspect, said dicyclopentadiene resin has a softening point in a range of from about 40 to about 140° C.

In a further aspect, said styrene-alphamethylstyrene resin has a softening point in a range of from about 65 to about 95° C.

Representative of such aforesaid triglyceride vegetable oils are, for example, at least one of soybean, sunflower, canola (rapeseed), corn, coconut, cottonseed, olive, palm, peanut, and safflower oils. Usually at least one of soybean, sunflower, canola and corn oil, and particularly soybean oil, is desired.

In one embodiment, said triglyceride based vegetable oils are composed of a mixture of naturally occurring triglycerides recovered from, for example soybeans, composed of at least one of, usually at least three of glycerol tri-esters of at least one and usually at least three unsaturated fatty acids. Such fatty acids are typically primarily comprised of, for example, of at least one of linolenic acid, linoleic acid, and oleic acid. For example, such combination of unsaturated fatty acids may be comprised of a blend of:

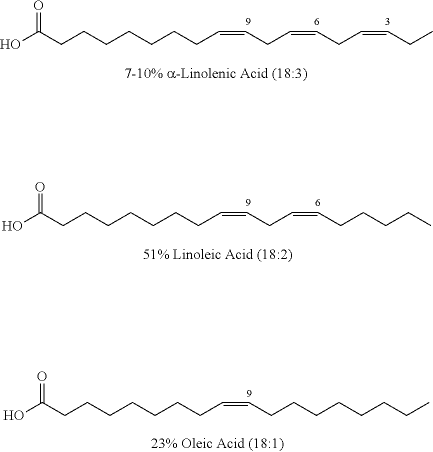 [SMILES: CC/C=C\C/C=C\C/C=C\CCCCCCCC(=O)O ; CCCCC/C=C\C/C=C\CCCCCCCC(=O)O ; CCCCCCCC/C=C\CCCCCCCC(=O)O]

In the case of soybean oil, for example, the above represented percent distribution, or combination, of the fatty acids for the glycerol tri-esters, namely the triglycerides, is represented as being an average value and may vary somewhat depending primarily on the type, or source of the soybean crop, and may also depend on the growing conditions of a particular soybean crop from which the soybean oil was obtained. There are also significant amounts of other saturated fatty acids typically present, though these usually do not exceed 20 percent of the soybean oil.

In a preferred embodiment, the functionalized diene-based elastomer, may be a functionalized elastomer containing, for example, at least one functional group comprised of at least one of amine, siloxy, carboxyl and hydroxyl groups, particularly functional groups reactive with hydroxyl groups (e.g. silanol groups) contained on precipitated silica.

In one embodiment, at least one of said diene-based elastomers may be a tin-coupled, or silicon coupled, particularly tin-coupled, elastomer (e.g. styrene/butadiene elastomer). Such coupled elastomer may, for example, be used to promote a beneficial improvement (reduction) in tire treadwear and a beneficial reduction in tire rolling resistance when used in tire tread rubber compositions. Such tin-coupled styrene/butadiene elastomer may be prepared, for example, by coupling the elastomer with a tin coupling agent at or near the end of the polymerization used in synthesizing the elastomer. In the coupling process, live polymer chain ends react with the tin coupling agent, thereby coupling the elastomer. For example, up to four live polymer chain ends can react with tin tetrahalides, such as tin tetrachloride, thereby coupling the polymer chains together.

The coupling efficiency of the tin coupling agent is dependant on many factors, such as the quantity of live chain ends available for coupling and the quantity and type of polar modifier, if any, employed in the polymerization. For instance, tin coupling agents are generally not as effective in the presence of polar modifiers. However, polar modifiers such as tetramethylethylenediamine, are frequently used to increase the glass transition temperature of the rubber for improved properties, such as improved traction characteristics in tire tread compounds. Coupling reactions that are carried out in the presence of polar modifiers typically have a coupling efficiency of about 50 to 60 percent in batch processes.

In cases where the tin coupled elastomer will be used in rubber compositions that are loaded primarily with carbon black reinforcement, the coupling agent for preparing the elastomer may typically be a tin halide. The tin halide will normally be a tin tetrahalide, such as tin tetrachloride, tin tetrabromide, tin tetrafluoride or tin tetraiodide. However, mono-alkyl tin trihalides can also optionally be used. Polymers coupled with mono-alkyl tin trihalides have a maximum of three arms. This is, of course, in contrast to elastomers coupled with tin tetrahalides which have a maximum of four arms. To induce a higher level of branching, tin tetrahalides are normally preferred. The tin tetrachloride is usually the most preferred.

In cases where the coupled elastomer may be used in compounds that are loaded with high levels of silica, the coupling agent for preparing the elastomer may, if desired, be a silicon halide. The silicon-coupling agents that can be used will normally be silicon tetrahalides, such as silicon tetrachloride, silicon tetrabromide, silicon tetrafluoride or silicon tetraiodide. However, mono-alkyl silicon trihalides can also optionally be used. Elastomers coupled with silicon trihalides have a maximum of three arms. This is, of course, in contrast to elastomers coupled with silicon tetrahalides during their manufacture which have a maximum of four arms. To induce a higher level of branching, if desired, of the elastomer during its manufacture, silicon tetrahalides are normally preferred. In general, silicon tetrachloride is usually the most desirable of the silicon-coupling agents for such purpose.

Representative examples of various diene-based elastomers are, for example, at least one of cis 1,4-polyisoprene, cis 1,4-polybutadiene, isoprene/butadiene, styrene/isoprene, styrene/butadiene and styrene/isoprene/butadiene elastomers. Additional examples of elastomers which may be used include 3,4-polyisoprene rubber, carboxylated rubber, silicon-coupled and tin-coupled star-branched elastomers. Often desired rubber or elastomers are cis 1,4-polybutadiene, styrene/butadiene rubber and cis 1,4-polyisorprene rubber.

Such precipitated silicas may, for example, be characterized by having a BET surface area, as measured using nitrogen gas, in the range of, for example, about 40 to about 600, and more usually in a range of about 50 to about 300 square meters per gram. The BET method of measuring surface area might be described, for example, in the Journal of the American Chemical Society, Volume 60, as well as ASTM D3037.

Such precipitated silicas may, for example, also be characterized by having a dibutylphthalate (DBP) absorption value, for example, in a range of about 100 to about 400, and more usually about 150 to about 300 cc/100 g.

The conventional precipitated silica might be expected to have an average ultimate particle size, for example, in the range of 0.01 to 0.05 micron as determined by the electron microscope, although the silica particles may be even smaller, or possibly larger, in size.

Various commercially available precipitated silicas may be used, such as, only for example herein, and without limitation, silicas from PPG Industries under the Hi-Sil trademark with designations 210, 243, etc; silicas from Rhodia, with, for example, designations of Z1165MP and Z165GR, silicas from Evonic with, for example, designations VN2 and VN3 and chemically treated precipitated silicas such as for example Agilon™ 400 from PPG.

Representative examples of rubber reinforcing carbon blacks are, for example, and not intended to be limiting, those with ASTM designations of N110, N121, N220, N231, N234, N242, N293, N299, S315, N326, N330, N332, N339, N343, N347, N351, N358, N375, N539, N550, N582, N630, N642, N650, N683, N754, N762, N765, N774, N787, N907, N908, N990 and N991. Such rubber reinforcing carbon blacks may have iodine absorptions ranging from, for example, 9 to 145 g/kg and DBP numbers ranging from 34 to 150 cc/100 g.

Other fillers may be used in the vulcanizable rubber composition including, but not limited to, particulate fillers including ultra high molecular weight polyethylene (UHMWPE); particulate polymer gels such as those disclosed in U.S. Pat. Nos. 6,242,534; 6,207,757; 6,133,364; 6,372,857; 5,395,891; or 6,127,488, and plasticized starch composite filler such as that disclosed in U.S. Pat. No. 5,672,639. One or more other fillers may be used in an amount ranging from about 1 to about 20 phr.

It may be desired for the precipitated silica-containing rubber composition to contain a silica coupling agent for the silica comprised of, for example,

(A) bis(3-trialkoxysilylalkyl)polysulfide containing an average in range of from about 2 to about 4 sulfur atoms in its connecting bridge, or

(B) an organoalkoxymercaptosilane, or

(C) their combination.

Representative of such bis(3-trialkoxysilylalkyl)polysulfide is comprised of bis(3-triethoxysilylpropyl)polysulfide.

It is readily understood by those having skill in the art that the vulcanizable rubber composition would be compounded by methods generally known in the rubber compounding art, such as, for example, mixing various additional sulfur-vulcanizable elastomers with said diene-based elastomer containing rubber composition and various commonly used additive materials such as, for example, sulfur and sulfur donor curatives, sulfur vulcanization curing aids, such as activators and retarders and processing additives, resins including tackifying resins and plasticizers, fillers such as rubber reinforcing fillers, pigments, fatty acid, zinc oxide, waxes, antioxidants and antiozonants and peptizing agents. As known to those skilled in the art, depending on the intended use of the sulfur vulcanizable and sulfur-vulcanized material (rubbers), the additives mentioned above are selected and commonly used in conventional amounts. Representative examples of sulfur donors include elemental sulfur (free sulfur), an amine disulfide, polymeric polysulfide and sulfur olefin adducts. Usually it is desired that the sulfur-vulcanizing agent is elemental sulfur. The sulfur-vulcanizing agent may be used in an amount ranging, for example, from about 0.5 to 8 phr, with a range of from 1.5 to 6 phr being often preferred. Typical amounts of tackifier resins, if used, may comprise, for example, about 0.5 to about 10 phr, usually about 1 to about 5 phr. Typical amounts of processing aids comprise about 1 to about 50 phr. Additional petroleum based rubber process oils, if desired, may be added in very low levels during the blending of the rubber composition in addition to the triglyceride vegetable oil(s), particularly soybean oil as the majority processing oil (e.g. less than 50 percent of the combination of vegetable and petroleum based processing oil). The additional petroleum based or derived rubber processing oils may include, for example, aromatic, paraffinic, napthenic, and low PCA oils such as MEW, TDAE, and heavy napthenic, although low PCA oils might be preferred. Typical amounts of antioxidants may comprise, for example, about 1 to about 5 phr. Representative antioxidants may be, for example, diphenyl-p-phenylenediamine and others, such as, for example, those disclosed in The Vanderbilt Rubber Handbook (1978), Pages 344 through 346. Typical amounts of antiozonants may comprise, for example, about 1 to 5 phr. Typical amounts of fatty acids, if used, which can include stearic acid comprise about 0.5 to about 3 phr. Typical amounts of zinc oxide may comprise, for example, about 2 to about 5 phr. Typical amounts of waxes comprise about 1 to about 5 phr. Often microcrystalline waxes are used. Typical amounts of peptizers, when used, may be used in amounts of, for example, about 0.1 to about 1 phr. Typical peptizers may be, for example, pentachlorothiophenol and dibenzamidodiphenyl disulfide.

Sulfur vulcanization accelerators are used to control the time and/or temperature required for vulcanization and to improve the properties of the vulcanizate. In one embodiment, a single accelerator system may be used, i.e., primary accelerator. The primary accelerator(s) may be used in total amounts ranging, for example, from about 0.5 to about 4, sometimes desirably about 0.8 to about 1.5, phr. In another embodiment, combinations of a primary and a secondary accelerator might be used with the secondary accelerator being used in smaller amounts, such as, for example, from about 0.05 to about 3 phr, in order to activate and to improve the properties of the vulcanizate. Combinations of these accelerators might be expected to produce a synergistic effect on the final properties and are somewhat better than those produced by use of either accelerator alone. In addition, delayed action accelerators may be used which are not affected by normal processing temperatures but produce a satisfactory cure at ordinary vulcanization temperatures. Vulcanization retarders might also be used. Suitable types of accelerators that may be used in the present invention are amines, disulfides, guanidines, thioureas, thiazoles, thiurams, sulfenamides, dithiocarbamates and xanthates. Often desirably the primary accelerator is a sulfenamide. If a second accelerator is used, the secondary accelerator is often desirably a guanidine such as for example a diphenylguanidine, a dithiocarbamate or a thiuram compound.

The mixing of the vulcanizable rubber composition can be accomplished by methods known to those having skill in the rubber mixing art. For example, the ingredients are typically mixed in at least two stages, namely at least one non-productive stage followed by a productive mix stage. The final curatives, including sulfur-vulcanizing agents, are typically mixed in the final stage which is conventionally called the “productive” mix stage in which the mixing typically occurs at a temperature, or ultimate temperature, lower than the mix temperature(s) than the preceding non-productive mix stage(s). The terms “non-productive” and “productive” mix stages are well known to those having skill in the rubber mixing art. The rubber composition may be subjected to a thermomechanical mixing step. The thermomechanical mixing step generally comprises a mechanical working in a mixer or extruder for a period of time suitable in order to produce a rubber temperature between 140° C. and 190° C. The appropriate duration of the thermomechanical working varies as a function of the operating conditions and the volume and nature of the components. For example, the thermomechanical working may be from 1 to 20 minutes.

The vulcanizable rubber composition containing the triglyceride oil extended SSBR may be incorporated in a variety of rubber components of an article of manufacture such as, for example, a tire. For example, the rubber component for the tire is a tread.

The pneumatic tire of the present invention may be a race tire, passenger tire, aircraft tire, agricultural, earthmover, off-the-road, truck tire and the like. Usually desirably the tire is a passenger or truck tire. The tire may also be a radial or bias ply tire, with a radial ply tire being usually desired.

Vulcanization of the pneumatic tire of the present invention is generally carried out at conventional temperatures in a range of, for example, from about 140° C. to 200° C. Often it is desired that the vulcanization is conducted at temperatures ranging from about 150° C. to 180° C. Any of the usual vulcanization processes may be used such as heating in a press or mold, heating with superheated steam or hot air. Such tires can be built, shaped, molded and cured by various methods which are known and will be readily apparent to those having skill in such art.

The following examples are presented for the purposes of illustrating and not limiting the present invention. All parts and percentages are parts by weight, usually parts by weight per 100 parts by weight rubber (phr) unless otherwise indicated.

### EXAMPLE I

In this example, the effect of using a triglyceride oil, namely soybean oil, as a replacement for petroleum based processing oil was investigated. For this Example, the rubber compositions evaluated were a 70/30 blend of functionalized solution polymerization prepared styrene/butadiene rubber (S-SBR) and high cis-polybutadiene rubber (PBD) with the addition of a traction resin to impart improved traction, particularly wet traction as well as the soybean oil. Oil extended elastomers were not used.

The rubber Samples were prepared by mixing the elastomers with silica as the major reinforcing filler. For such preparation, ingredients, other than sulfur and sulfur accelerator curatives, were mixed a first non-productive mixing stage (NP1) in an internal rubber mixer for about 4 minutes to a temperature of about 160° C. The resulting mixture was subsequently mixed in a second sequential non-productive mixing stage (NP2) in an internal rubber mixer to a temperature of about 160° C. with no additional ingredients added. The rubber composition was subsequently mixed in a productive mixing stage (P) in an internal rubber mixer with a sulfur cure package, namely sulfur and sulfur cure accelerator(s), for about 2 minutes to a temperature of about 115° C. The rubber composition is removed from its internal mixer after each mixing step and cooled to below 40° C. between each individual non-productive mixing stage and before the final productive mixing stage.

The basic formulation for the Control rubber Sample A and Experimental rubber Samples is presented in the following Table 1 expressed in parts by weight per 100 parts of rubber (phr) unless otherwise indicated.

TABLE 1

| | Parts by weight (phr) |
|---|---|
| Non-Productive Mixing Stage (NP1) | |
| Styrene/butadiene rubber (S-SBR)¹ | 70 or 50 |
| Cis 1,4-polybutadiene rubber (PBD)² | 30 or 50 |
| Precipitated silica³ | 65 |
| Silica coupler⁴ | 5 |
| Carbon black⁵ | 4 |
| Wax | 1.5 |
| Zinc oxide | 3.5 |
| Fatty acid⁶ | 2 |
| Processing oil, petroleum derived (naphthenic)⁷ | 12 or 20 |
| Soybean oil⁸ | 12 or 20 |
| Traction resin⁹ | 0 or 15 |
| Productive Mixing Stage (P) | |
| Sulfur | 1.7 |
| Sulfur cure accelerator(s)¹⁰ | 3.1 |
| Antioxidant | 3 |

¹Styrene/butadiene, solution polymerization prepared, functionalized copolymer rubber as SLR 4602 from Styron company, understood to be a tin coupled styrene/butadiene elastomer containing end siloxy functional groups reactive with hydroxyl groups of precipitated silica.
²Cis-polybutadiene rubber as BUD1207 from The Goodyear Tire & Rubber Company
³Precipitated silica as Zeosil Z1165 MP from the Rhodia Company
⁴Silica coupler as Si266 ™ from the Evonic Company, comprised of a bis (3-triethoxysilylpropyl) polysulfide containing an average of from about 2 to about 2.4 connecting sulfur atoms in its polysulfidic bridge
⁵N550 rubber reinforcing carbon black, ASTM identification
⁶Primarily comprised of stearic, palmitic and oleic acids
⁷Petroleum based rubber processing oil as Naprex 38 from ExxonMobil Company
⁸Soybean oil as Sterling Oil from the Stratas Foods Company
⁹Traction resin as styrene/alpha-methylstyrene resin as Resin 2336 ™ from the Eastman Chemical Company
¹⁰Sulfenamide and diphenylguanidine accelerators

The following Table 2 illustrates cure behavior and various physical properties of rubber compositions based upon the basic recipe of Table 1. Where cured rubber samples are examined, such as for the stress-strain, hot rebound and hardness values, the rubber samples were cured for about 14 minutes at a temperature of about 160° C.

TABLE 2

| | Parts (phr) | | | | | |
|---|---|---|---|---|---|---|
| | A | B | C | D | E | F |
| Rubber Samples | | | | | | |
| S-SBR | 70 | 70 | 70 | 50 | 50 | 50 |
| PBD | 30 | 30 | 30 | 50 | 50 | 50 |
| Petroleum processing oil | 20 | 12 | 0 | 20 | 12 | 0 |
| Soybean oil | 0 | 0 | 12 | 0 | 0 | 12 |
| Traction resin | 0 | 15 | 15 | 0 | 15 | 15 |
| Wet Traction Indication (For | | | | | | |
| Tread Running Surface) - | | | | | | |
| Lower Is Better | | | | | | |
| Cold (0° C.) rebound value | 24.3 | 13.4 | 14.4 | 36.1 | 25.7 | 26.3 |
| Abrasion Resistance (Wear | | | | | | |
| Resistance Indicator) - Lower | | | | | | |
| is Better | | | | | | |
| Grosch¹ rate of abrasion | 487 | 527 | 489 | 475 | 492 | 476 |
| (mg/km), high severity (70N), | | | | | | |
| 16° slip angle, disk speed = | | | | | | |
| 20 km/hr, distance = 500 m | | | | | | |
| Rolling Resistance (Hysteresis) | | | | | | |
| Indication | | | | | | |
| Hot rebound (100° C.) | 66 | 64 | 63 | 62 | 60 | 58 |
| value (higher is better) | | | | | | |
| Tan delta (100° C.), | 0.065 | 0.076 | 0.082 | 0.074 | 0.079 | 0.08 |
| 10% strain, 11 Hz | | | | | | |
| (lower is better) | | | | | | |
| Tear strength² 95° (N) | 71 | 84 | 104 | 84 | 98 | 107 |
| (higher is better) | | | | | | |

¹Grosch abrasion rate determination was run on an LAT-100 Abrader and measured in terms of mg/km of rubber abraded away. The test rubber sample is placed at a slip angle under constant load (Newtons) as it traverses a given distance on a rotating abrasive disk (disk from HB Schleifmittel GmbH). A high severity test was conducted at a load of 70 Newtons, a slip angle of 2 degrees and a disk speed of 20 km/hr and a sample travel distance of 250 meters.
²Data obtained according to a tear strength (peal adhesion) test to determine interfacial adhesion between two samples of a rubber composition. In particular, such interfacial adhesion is determined by pulling one rubber composition away from the other at a right angle to the untorn test specimen with the two ends of the rubber compositions being pulled apart at a 180° angle to each other using an Instron instrument at 95° C. and reported as Newtons force.

Rubber samples A and D are Control rubber Samples that contained a blend of 70 phr functionalized S-SBR with 30 phr cis-PBD (for rubber Sample A) and 50 phr functionalized S-SBR with 50 phr cis-PBD (for rubber Sample D).

Rubber Samples B and E are comparative rubber Samples in which 15 phr of a traction resin has replaced 8 phr of petroleum based rubber processing oil used in Control rubber Samples A and D.

Rubber Samples C and F are Experimental rubber Samples, similar to comparative Samples B and E, respectively, except they contain soybean oil in place of the petroleum based processing oil and also contain 15 phr of the traction resin.

As seen in Table 2, the results clearly show the benefit of the soybean oil, in Experimental rubber Samples C and F, when used as replacement for the petroleum based rubber processing oil, when used in combination with a traction resin when compared to Comparative rubber Samples B and E. For example, when comparing Comparative rubber Sample B with Experimental rubber Sample C and when comparing Comparative rubber Sample E with Experimental rubber Sample F, one can see similar results for traction and rolling resistance predictors with an advantage in abrasion and tear resistance for Experimental rubber Samples C and F, which contain the soybean oil in place of the petroleum based rubber processing oil.

Therefore, it is concluded that this evaluation has successfully shown the advantage of replacing petroleum based processing oil with a vegetable, oil, namely soybean oil, in a rubber blend composition of a functionalized solution SBR and high cis-PBD in the presence of a traction resin. The results clearly show that one can improve the traction prediction of such compounds without giving up other critical properties such as abrasion and tear resistance while maintaining similar rolling resistance predicted performance.

While certain representative embodiments and details have been shown for the purpose of illustrating the subject invention, it will be apparent to those skilled in this art that various changes and modifications can be made therein without departing from the scope of the subject invention.

1. A rubber composition comprised of, based on parts by weight per 100 parts by weight of elastomer (phr):
(A) at least one conjugated diene-based elastomer, including at least one conjugated diene-based elastomer that contains one or more functional groups reactive with hydroxyl groups contained on precipitated silica, and
(B) from about 5 to about 60, phr of triglyceride vegetable oil consisting of at least one triglyceride vegetable oil having a poly unsaturated content of at least 40 percent, and
(C) from about 1 to about 30 phr of resin comprised of at least one of coumarone-indene resins, alkylated hydrocarbon resins, aromatic petroleum resins, dicyclopentadiene resins and styrene-alphamethylstyrene resins, and
(D) from about 30 to about 140 phr of reinforcing filler consisting of:
(1) precipitated silica, or
(2) combination of rubber reinforcing carbon black and precipitated silica,
(E) silica coupling agent reactive with hydroxyl groups contained on said precipitated silica and another different moiety interactive with carbon-to-carbon double bonds of said conjugated diene-based elastomers;
wherein said rubber composition is free of petroleum oil extended elastomer.

2. The rubber composition of claim 1 wherein said triglyceride vegetable oil consists essentially of soybean oil.

3. The rubber composition of claim 2 wherein said reinforcing filler consists of a combination of rubber reinforcing carbon black and precipitated silica.

4. The rubber composition of claim 1 wherein said triglyceride vegetable oil is exclusive of petroleum based oil.

5. The rubber composition of claim 1 which contains petroleum based rubber processing oil blended with the rubber composition in addition to said vegetable oil in an amount less than 50 percent of the combination of rubber processing oil and vegetable oil.

6. The rubber composition of claim 1 wherein said resin is comprised of one of said resins.

7. The rubber composition of claim 1 wherein said resin is comprised of two of the same or different of said resins having individual softening points spaced apart by at least 20° C. from each other.

8. The rubber composition of claim 1 wherein said resin is comprised of three of said resins having individual softening points spaced apart by at least 20° C. from each other.

9. (canceled)

10. The rubber composition of claim 1 wherein said coumarone-indene resin has a softening point in a range of from about 20 to about 140° C.

11. The rubber composition of claim 1 wherein said alkylated hydrocarbon resin has a softening point in a range of from about 40 to about 140° C.

12. The rubber composition of claim 1 wherein said aromatic petroleum resin has a softening point in a range of from about 40 to about 160° C.

13. The rubber composition of claim 1 wherein said dicyclopentadiene resin has a softening point in a range of from about 40 to about 140° C.

14. The rubber composition of claim 1 wherein said styrene-alphamethylstyrene resin has a softening point in a range of from about 65° to about 95° C.

15. The rubber composition of claim 1 wherein said functionalized diene-based elastomer contains at least one functional group comprised of at least one of amine, siloxy, carboxyl and hydroxyl groups reactive with hydroxyl groups contained on said precipitated silica.

16. The rubber composition of claim 1 wherein at least one of said diene-based elastomers is a tin or silicon coupled elastomer.

17. The rubber composition of claim 15 wherein at least one of said diene-based elastomer is a tin or silicon coupled elastomer.

18. A tire having a tread comprised of the rubber composition of claim 1.

19. A tire having a tread comprised of the rubber composition of claim 15.

20. A tire having a tread comprised of the rubber composition of claim 6.

21. The rubber composition of claim 15 wherein at least one of said diene-based elastomers is a tin or silicon coupled elastomer.
